(19) United States
(12) Patent Application Publication
(10) Pub. No.: US 2010/0038037 A1
(43) Pub. Date: Feb. 18, 2010

(54) Apparatus for applying a film to a bottom side of an extruded sheet

(76) Inventors: Dana Ray Hanson, St. Charles, IL (US); Mitchell Lee Gritzner, Montgomery, IL (US); Ryan Edward Leopold, Sycamore, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/228,460

(22) Filed: Aug. 13, 2008

(51) Int. Cl. B32B 37/00

(52) U.S. Cl. 156/391

(57) ABSTRACT

An apparatus for applying a film to a bottom side of an extruded sheet. The apparatus has an upstream end and a downstream end to which a completed product is directed. The apparatus has: an extruder assembly for forming an extruded sheet; a roll stack assembly with a first plurality of rolls against which an extruded sheet is formed by the extruder assembly and guided as the extruded sheet is advanced towards the downstream end of the apparatus; and a first station for a supply of film that can be applied to the bottom side of an extruded sheet formed by the extruder assembly at the roll stack assembly. The first station for a supply of film is upstream of the roll stack assembly.

### BACKGROUND OF THE INVENTION

1. Field of the Invention

This invention relates to extruded sheets and, more particularly, to an apparatus for continuously applying a film to a bottom side of an extruded sheet layer.

2. Background Art

Extruded sheets are formed for a multitude of different uses. Certain products require the application of a film layer to the bottom side of an extruded sheet layer.

In one known system configuration for making sheets of this type, film rolls are stored downstream of a roll stack and film is guided therefrom continuously upstream to an appropriate lamination location on the roll stack. This film supply location may add undesirably to the overall lengthwise extent of the system and may further require an elaborate structure to both route the film to the roll stack and thereafter route the extruded layer with the applied film past the roll supply station to the downstream end of the apparatus where the end product is accumulated.

This type of equipment has also generally been made with a fixed, skeletal frame between the upstream and downstream ends thereof. A film supply station, extruder assembly, roll stack, etc. are all integrated into this framework. While this configuration performs effectively, in the event that there is a malfunction, or regular maintenance needs to be conducted, it may be difficult to access particular components. For example, if access to the roll stack is required, portions of the extruder may have to be disassembled to make this possible.

While these problems have existed and persisted for years, the industry has contended with them because there have not existed viable alternatives to these basic structures that would address and potentially overcome the noted problems.

### SUMMARY OF THE INVENTION

In one form, the invention is directed to an apparatus for applying a film to a bottom side of an extruded sheet. The apparatus has an upstream end and a downstream end to which a completed product is directed. The apparatus has: an extruder assembly for forming an extruded sheet; a roll stack assembly with a first plurality of rolls against which an extruded sheet is formed by the extruder assembly and guided as the extruded sheet is advanced towards the downstream end of the apparatus; and a first station for a supply of film that can be applied to the bottom side of an extruded sheet formed by the extruder assembly at the roll stack assembly. The first station is upstream of the roll stack assembly.

In one form, the apparatus may be provided in combination with a supply of film at the first station.

In one form, the extruder assembly projects over the supply of film at the first station.

In one form, at least part of each of the extruder assembly and first station for the supply of film is incorporated into a first module that is a unit that is separate from the roll stack assembly.

In one form, the first module further has a second plurality of rolls against which film from the supply can be placed selectively in a manner to alternatively guide film from the supply towards: (a) a first primary lamination/nip point on the roll stack assembly; and (b) a second/secondary lamination/nip point on the roll stack assembly that is spaced from the first/primary lamination/nip point.

In one form, the first/primary lamination/nip point is above the supply of film.

In one form, the first module includes a second plurality of rolls against which film from the supply can be placed selectively in a manner to guide film from the supply towards a first lamination/nip point on the roll stack assembly. The extruder assembly includes a sheet die that is configured to deliver material to form an extruded sheet with a top side and bottom side at the first lamination/nip point at which the film can be applied to the bottom side of the extruded sheet.

In one form, the first module further includes a second plurality of rolls against which film from the supply can be placed selectively in a manner to guide film from the supply towards one lamination/nip point on the roll stack assembly. The extruder assembly has a sheet die that is configured to deliver material to form an extruded sheet with a top side and bottom side at another lamination/nip point that is upstream of the one lamination/nip point. The film is capable of being applied to the bottom side of the extruded sheet.

In one form, the apparatus may be provided in combination with an extruded sheet formed by the extruder assembly.

In one form, the extruded sheet is made from a plastic material.

In one form, the roll stack assembly is part of a second module that is a unit that is separate from the first module.

In one form, the supply of film includes a first roll of the film on the first module.

The supply of film may include a second roll of the film on the first module.

In one form, the extruder assembly has a lengthwise extent between upstream and downstream ends of the first module and the film rolls reside within the lengthwise extent of the extruder assembly.

In one form, the film is directed in a downstream direction up to and against one of the rolls in the first plurality of rolls at the first/primary lamination/nip point.

In one form, the film is directed in a downstream direction up to and against one of the rolls in the first plurality of rolls at the second/secondary lamination/nip point.

In one form, the apparatus has a substantially straight configuration between the upstream and downstream ends.

In one form, the second module additionally has at least one pull roll that is configured to draw a web, including the film and an extruded sheet formed by the extruder assembly, in a downstream direction.

In one form, at least one of the first and second modules is movable relative to the other of the first and second modules to expose, for access, upstream components on the second module and downstream components on the first module.

In one form, the roll stack has a widthwise extent and the first and second modules are relatively repositionable to expose the full widthwise extent of the roll stack.

### BRIEF DESCRIPTION OF THE DRAWINGS

FIG. 1 is a side elevation view of an apparatus for applying a film to a bottom side of an extruded sheet, according to the present invention, and showing alternative film paths in which the film is applied to an extruded sheet at primary and secondary lamination/nip points;

FIG. 2 is a perspective view of the apparatus in FIG. 1 with the film guided for application at the primary lamination/nip point;

FIG. 3 is a view of the system as in FIG. 2 from a different perspective;

FIG. 4 is a view corresponding to that in FIG. 2 with the film guided for application to the extruded sheet at the secondary lamination/nip point;

FIG. 5 is a view of the apparatus as in FIG. 4 from a different perspective;

FIG. 6 is a schematic plan view of first and second modules that make up the apparatus in FIGS. 1-5;

FIG. 7 is a view as in FIG. 6 wherein the modules are relatively repositioned to allow access to components thereon; and

FIG. 8 is a fragmentary, side elevation view of a conventional apparatus for applying a film to a bottom side of an extruded sheet.

### DETAILED DESCRIPTION OF THE PREFERRED EMBODIMENT

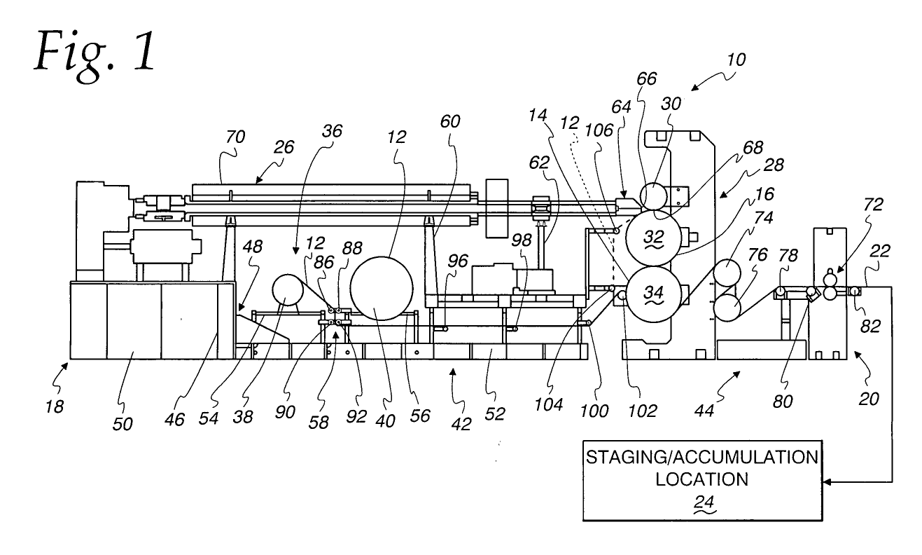

In FIGS. 1-7, an apparatus is shown at 10 for applying a film 12 to a bottom side 14 of an extruded sheet 16. The apparatus 10 has an upstream end 18 and a downstream end 20 towards which a completed product 22 is continuously directed. The completed product 22 departing the apparatus 10 at the downstream end 20 is delivered to a staging/accumulation location 24, or to any other point of use.

The apparatus 10 consists of an extruder assembly 26, of conventional construction, for delivering an appropriate material, such as plastic, to form the extruded sheet 16.

The apparatus 10 further consists of a roll stack assembly 28 made up of a plurality of rolls, and in this case, three chrome rolls 30,32,34 against which the extruded sheet 16 is formed by the extruder assembly 26. The extruded sheet 16 is guided by the rolls 32,34 as it is advanced towards the downstream end 20 of the apparatus 20.

The apparatus 10 further consists of an unwind station at 36 in which one, and in this case two, separate rolls 38,40 of film 12 are mounted. One of the rolls 38,40 is active, with the other available as a backup upon exhaustion of film 12 from the one roll. The unwind station 36 is located upstream of the roll stack assembly 28.

The apparatus 10 is made up of separate first and second modules 42,44 that are self-contained units, each separate from the other. As explained below, at least one of the modules 42,44 is movable relative to the other to permit strategic access to components with the apparatus 10 in a down state.

The first module 42 consists of a frame 46 with a stepped base 48, with a higher base portion 50 and a lower base portion 52.

The film rolls 38,40 are separately mounted upon stands 54,56, respectively, in conventional fashion. A guide roll assembly 58 resides between the stands 54,56 to direct film 12 from either roll 38,40 in a transverse path initially downwardly and then horizontally towards the downstream end 20 of the apparatus.

The extruder assembly 26 has a conventional construction and is supported cooperatively by the base portion 50 and separate vertical supports 60,62 projecting upwardly from the lower base potion 52. The extruder assembly 26 has a sheet die 64 with a material discharge 66 for delivery of material against the roll 32 at a primary lamination/nip point 68 at a vertical location between the rolls 30,32.

As depicted, a main extruder component 70, supported upon the base portion 50 and vertical supports 60, projects over and spans fully the lengthwise extent of the unwind station 36 and the film rolls 38,40 thereat. Thus, the film rolls 38,40 lie fully within the lengthwise extent of the extruder assembly 26, and more specifically the main extruder component 70, so as to afford a compact, lengthwise design. At the same time, the film rolls 38,40 reside at a convenient height for installation and replacement.

The apparatus 10 further includes a pull roll assembly 72 at the downstream end of the apparatus 20. At least one roll 73 on the assembly 72 is designed to draw the completed product 22, in web form, away from the roll stack assembly 28 and towards the downstream end 20 of the apparatus 10.

A plurality of strategically placed rolls 74,76,78,80,82 is provided downstream of the rolls 30,32,34 to control web tension and situate the web 22 to be pulled and advanced by the pull roll assembly 72.

The first module 42 has a plurality of rolls, including the rolls 86,88,90,92, defining the guide roll assembly 58, and rolls 96,98,100,102, 104,106, in addition to the rolls on the guide roll assembly 58, against which film 12 from the rolls 38,40 can be trained to direct the film 12 selectively in a downstream direction to either the primary lamination/nip point 68, previously described, or a secondary lamination/nip point 110, between the rolls 34,102 beneath the primary lamination/nip point 68. In each configuration, the film 12 is directed in a downstream direction up to and against each of the lamination/nip points 68,110.

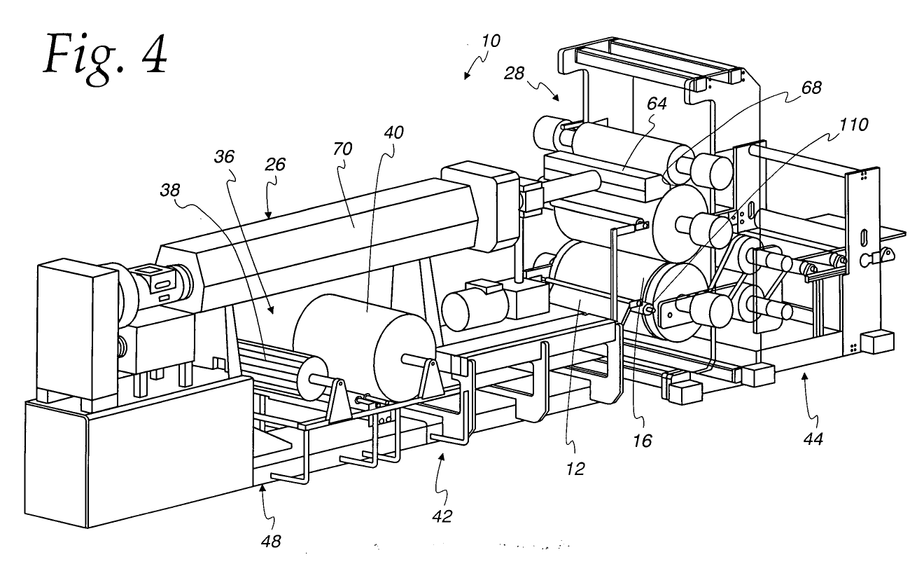

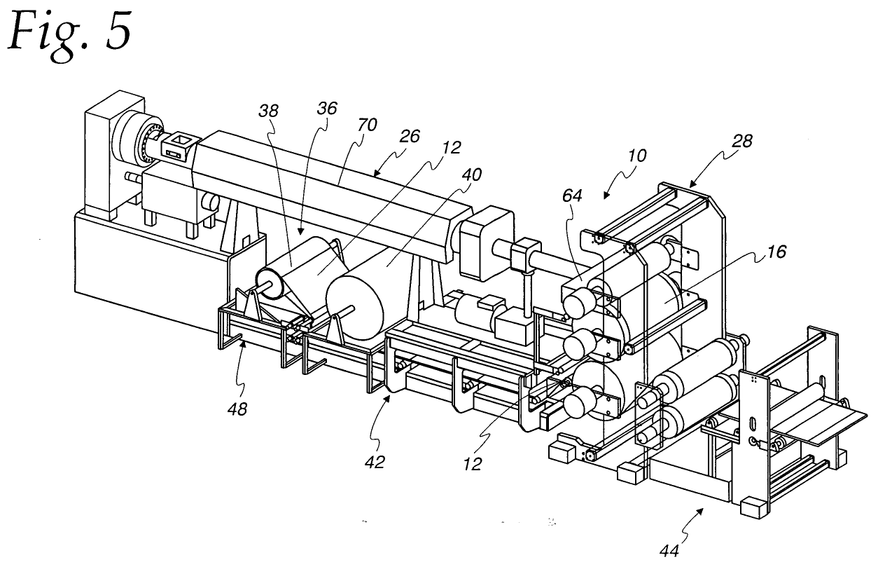

In one configuration, shown in FIGS. 4 and 5, the film 12 is directed from the guide roll assembly 58 against the tops of the rolls 96,98, wrapped partially around the roll 100 from the underside thereof, and partially around the roll 102 at the upper region thereof to the secondary lamination/nip point 110. At that location, the film 12 is applied to the bottom side 14 of the extruded sheet 16 that has advanced downwardly around and between the chrome rolls 32,34.

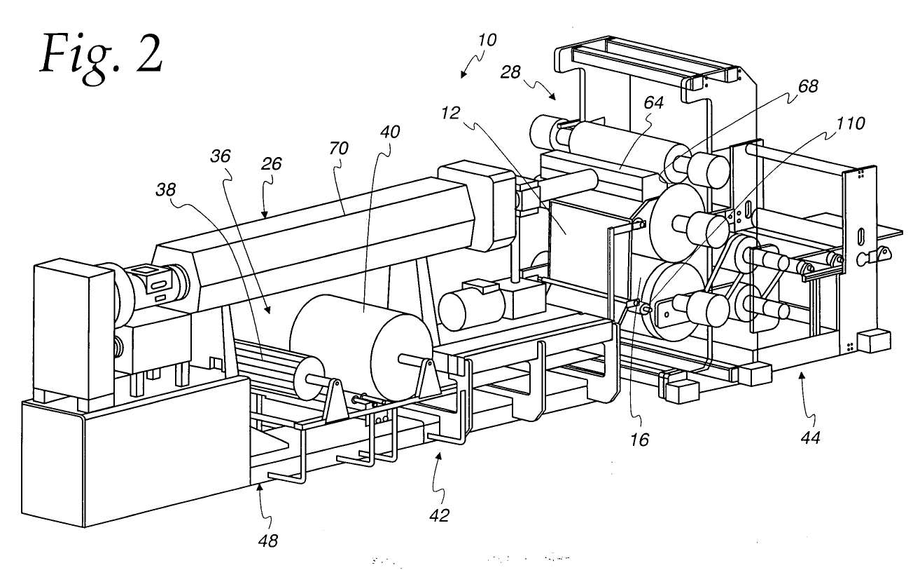

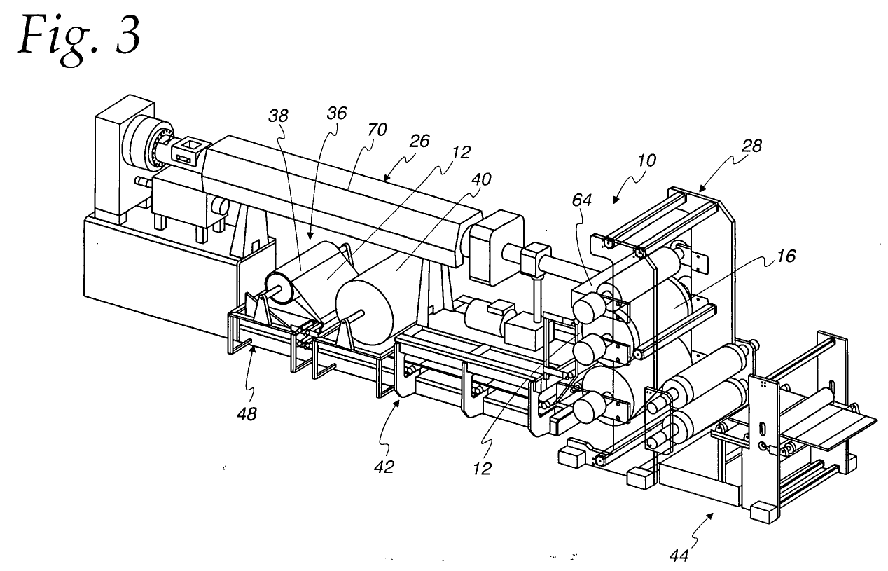

Alternatively, as shown partially in dotted lines in FIG. 1, and additionally in FIGS. 2 and 3, the film 12 can be directed from the roll 100 against the downstream portion of the roll 104, and upstream portion of the roll 106, which functions as a spreader roll upstream of the primary lamination/nip point 68. In this arrangement, the film 12 departs from the spreader roll 106 and moves to the primary lamination/nip point 68 whereat it is applied to the bottom side 14 of the extruded sheet 16.

Typically, at the primary lamination/nip point, molten polymer discharging from the sheet die 64 is combined with the film 12. This produces a very strong bond. However, lamination at this location may not be appropriate when the film 12 is temperature-sensitive or very high temperature polymers are used. Under those circumstances, the film 12 may be prone to melting or otherwise becoming damaged due to the high temperatures encountered at the primary lamination/nip point 68. The secondary lamination/nip point 110 thus offers an alternative location whereby the temperature problems can be avoided while still producing an effective bond between the applied film 12 and extruded sheet 16.

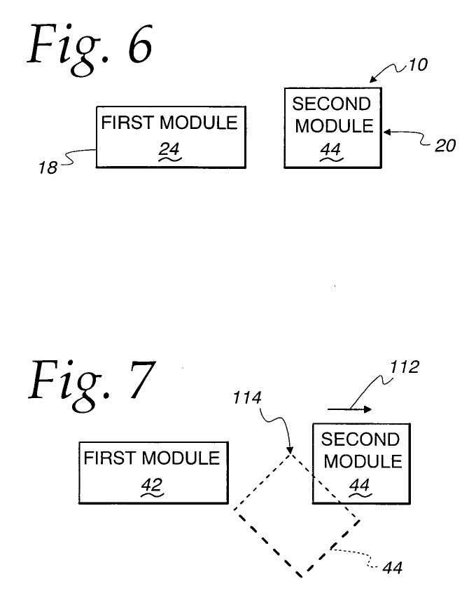

As depicted in FIGS. 1-5, and as further clarified schematically in FIGS. 6 and 7, the apparatus 10 has a generally straight/linear configuration between its upstream and downstream ends 18,20. This overall configuration is defined cooperatively by the first module 42 and the second module 44. The first module 42 functions as a separate unit that delivers extruded material to the roll stack assembly 28 and additionally guides the film 12 to locations alternatively immediately upstream of the primary and secondary lamination/nip points 68,110. The second module 44 functions as a separate unit that is a web take-off unit.

At least one, and potentially both, of the modules 42,44 are moveable, each relative to the other, to produce a system configuration that allows access to components directly between the modules 42,44.

In FIG. 7, one exemplary reconfiguration is shown wherein the second module is translated lengthwise, in the direction of the arrow 112, to create a gap 114 between the modules 42,44 through which access can be gained to upstream components on the second module 44 and downstream components on the first module 42. This feature is particularly desirable to facilitate routine maintenance on the extruder assembly 26. Commonly, a feed screw on the extruder component 70 may have to be extracted for cleaning. Other components, such as the sheet die 64 and other components on both modules 42,44, may require regular access for maintenance/cleaning, adjustment and repair, that is facilitated by the inventive design.

Alternatively, the modules 42,44 can be relatively angularly moved, as depicted by the dotted line position for the second module 44 in FIG. 7, whereby access can be gained selectively to part, or the entirety, of the widthwise extent of the components on the downstream end of the first module 42 and upstream end of the second module 44. By having the extruder assembly 26 separate from the roll stack assembly 28, potentially unobstructed access can be gained to both the full width of the rolls 30,32,34, in the roll stack assembly 28, and the sheet die 64.

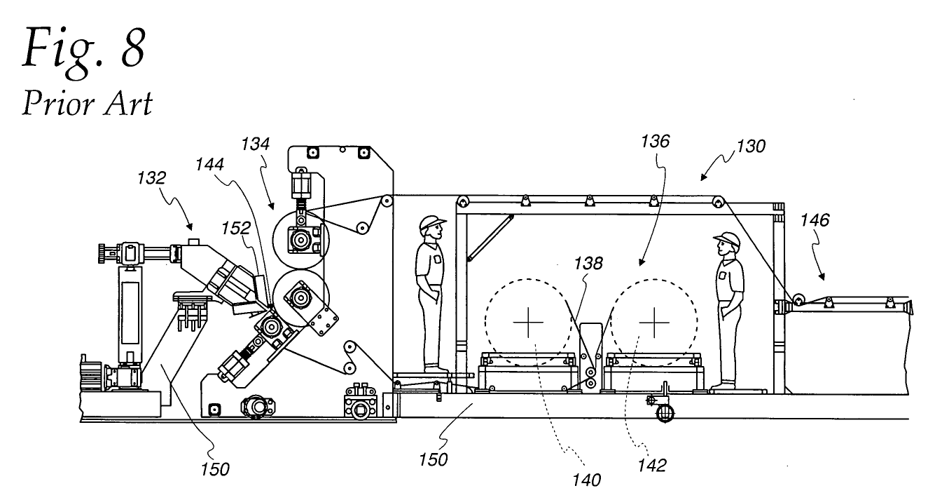

In FIG. 8, a conventional apparatus, as briefly described in the Background section herein, is shown at 130. The apparatus 130 consists of an extruder assembly 132, a roll stack assembly 134, and a film unwind station at 136. The film unwind station 136 is downstream of both the extruder assembly 132 and roll stack assembly 134. Film 138 is controllably guidingly directed in an upstream direction from separate rolls 140,142 to a lamination/nip point 144 whereat it is applied to the bottom side of an extruded sheet and thereafter delivered along the top of the film unwind station 136 downstream to a station at 146 at which the completed product is drawn to an appropriate location for accumulation. The completed product, moving in the elevated path in a downstream direction, obstructs potentially desired overhead access to system components.

Further, the depicted path for the film 138 makes it difficult to set the system up. One exemplary problem area, in terms of training the film 138 around/against rolls that will establish its path, is at the bottom chrome roll on the roll stack assembly 134.

As can be seen, the components on the apparatus 130 are all integrated into the same skeletal framework 150 that extends fully between the upstream and downstream ends of the apparatus. As a result, if access to a sheet die 152 is required, a substantial disassembly of components may be required to allow this to occur.

The foregoing disclosure of specific embodiments is intended to be illustrative of the broad concepts comprehended by the invention.

1. An apparatus for applying a film to a bottom side of an extruded sheet, the apparatus having an upstream end and a downstream end to which a completed product is directed, the apparatus comprising:
an extruder assembly for forming an extruded sheet;
a roll stack assembly comprising a first plurality of rolls against which an extruded sheet is formed by the extruder assembly and guided as the extruded sheet is advanced towards the downstream end of the apparatus; and
a first station for a supply of film that can be applied to the bottom side of an extruded sheet formed by the extruder assembly at the roll stack assembly,
wherein the first station for a supply of film is upstream of the roll stack assembly.

2. The apparatus for applying a film to a bottom side of an extruded sheet according to claim 1, in combination with a supply of film at the first station.

3. The apparatus for applying a film to a bottom side of an extruded sheet according to claim 2, wherein the extruder assembly projects over the supply of film at the first station.

4. The apparatus for applying a film to a bottom side of an extruded sheet according to claim 2, wherein at least part of each of the extruder assembly and first station for the supply of film is incorporated into a first module that is a unit that is separate from the roll stack assembly.

5. The apparatus for applying a film to a bottom side of an extruded sheet according to claim 4, wherein the first module further comprises a second plurality of rolls against which film from the supply can be placed selectively in a manner to alternatively guide film from the supply towards: (a) a first primary lamination/nip point on the roll stack assembly; and (b) a second/secondary lamination/nip point on the roll stack assembly that is spaced from the first/primary lamination/nip point.

6. The apparatus for applying a film to a bottom side of an extruded sheet according to claim 5, wherein the first/primary lamination/nip point is above the supply of film.

7. The apparatus for applying a film to a bottom side of an extruded sheet according to claim 4, wherein the first module further comprises a second plurality of rolls against which film from the supply can be placed selectively in a manner to guide film from the supply towards a first lamination/nip point on the roll stack assembly and the extruder assembly comprises a sheet die that is configured to deliver material to form an extruded sheet with a top side and bottom side at the first lamination/nip point at which the film can be applied to the bottom side of the extruded sheet.

8. The apparatus for applying a film to a bottom side of an extruded sheet according to claim 4, wherein the first module further comprises a second plurality of rolls against which film from the supply can be placed selectively in a manner to guide film from the supply towards one lamination/nip point on the roll stack assembly and the extruder assembly comprises a sheet die that is configured to deliver material to form an extruded sheet with a top side and bottom side at another lamination/nip point that is upstream of the one lamination/nip point, the film capable of being applied to the bottom side of the extruded sheet.

9. The apparatus for applying a film to a bottom side of an extruded sheet according to claim 2, in combination with an extruded sheet formed by the extruder assembly.

10. The apparatus for applying a film to a bottom side of an extruded sheet according to claim 9, wherein the extruded sheet comprises a plastic material.

11. The apparatus for applying a film to a bottom side of an extruded sheet according to claim 4, wherein the roll stack assembly is part of a second module that is a unit that is separate from the first module.

12. The apparatus for applying a film to a bottom side of an extruded sheet according to claim 4, wherein the supply of film comprises a first roll of the film on the first module.

13. The apparatus for applying a film to a bottom side of an extruded sheet according to claim 12, wherein the supply of film comprises a second roll of the film on the first module.

14. The apparatus for applying a film to a bottom side of an extruded sheet according to claim 13, wherein the extruder assembly has a lengthwise extent between upstream and downstream ends of the first module and the film rolls reside within the lengthwise extent of the extruder assembly.

15. The apparatus for applying a film to a bottom side of an extruded sheet according to claim 5, wherein the film is directed in a downstream direction up to and against one of the rolls in the first plurality of rolls at the first/primary lamination/nip point.

16. The apparatus for applying a film to a bottom side of an extruded sheet according to claim 5, wherein the film is directed in a downstream direction up to and against one of the rolls in the first plurality of rolls at the second/secondary lamination/nip point.

17. The apparatus for applying a film to a bottom side of an extruded sheet according to claim 2, wherein the apparatus has a substantially straight configuration between the upstream and downstream ends.

18. The apparatus for applying a film to a bottom side of an extruded sheet according to claim 11, wherein the second module additionally comprises at least one pull roll that is configured to draw a web, comprising the film and an extruded sheet formed by the extruder assembly, in a downstream direction.

19. The apparatus for applying a film to a bottom side of an extruded sheet according to claim 11, wherein at least one of the first and second modules is movable relative to the other of the first and second modules to expose for access upstream components on the second module and downstream components on the first module.

20. The apparatus for applying a film to a bottom side of an extruded sheet according to claim 19, wherein the roll stack has a widthwise extent and the first and second modules are relatively repositionable to expose the full widthwise extent of the roll stack.
